(19) United States
(12) Patent Application Publication
(10) Pub. No.: US 2015/0276316 A1
(43) Pub. Date: Oct. 1, 2015

(54) THERMAL TREATMENT OF TILES

(71) Applicant: ASTC TECNOLOGIA LTDA., São Paulo-SP (BR)

(72) Inventor: Ernesto Adolfo Hartschuh Schaub, Sao Paulo (BR)

(73) Assignee: ASTC Technolgies Ltda., Sau Paulo (BR)

(21) Appl. No.: 14/437,154

(22) PCT Filed: Oct. 25, 2013
(86) PCT No.: PCT/BR2013/000438

§ 371 Date: Apr. 20, 2015

(30) Foreign Application Priority Data
Oct. 26, 2012 (BR) BR 10 2012 027523

(51) Int. Cl. F27B 9/36

(52) U.S. Cl. CPC F27B 9/36; F27B 2009/3638

(57) ABSTRACT

The present invention relates to a combustion system for the production of linings, comprising a roller furnace having walls with insulations, and being divided into different regions with different temperatures, the burning zone (3) of the system further comprising a plurality of burners (2, 4), in which the burners (2, 4) are located in the ceiling and/or in the floor and/or in the sides of the furnace and preferably burn in the direction contrary to the direction of advance of the load, horizontally.

### CROSS REFERENCE TO RELATED APPLICATIONS

This application is a National Stage Application, filed under 35 U.S.C. §371, of International Application No. PCT/BR2013/000438, filed Oct. 25, 2013, which claims priority to and the benefit of Brazilian Application No. BR12012027523-6, filed Oct. 26, 2012; the contents of both of which as are hereby incorporated by reference in their entirety.

### BACKGROUND

1. Technical Field

This invention refers to an improved combustion and cooling system for industrial kilns more specifically for roller kilns intended for the manufacturing of ceramic specifically of floor and wall tiles.

2. Description of Related Art

Roller tunnel-type kilns are widely known in the state of the art, and they have been used for decades for the firing of wall and floor tiles, etc.

The operation of such kilns basically takes place as follows: ceramic products, bricks, etc., hereinafter referred to as the “charge”, enter the kiln in their “raw” form and travel toward the opposite side, coming out of the kiln in the “fired” form. However, for each product to be fired, there are different ideal curves of internal temperatures for each section of the kiln, in order to provide the fired products with the desired structural properties. For instance, for earthenware, temperatures are around 1000° C. For sanitary ware temperatures are around 1200° C. Other temperature ranges, such as 1450° C. for hard chinaware, 1600° C. for high alumina materials, and up to 1850° C. for the burning of basic bricks (used in blast furnaces) can also be found. Such tunnel kiln's thermal yield is very good in comparison with intermittent' kiln's one. Among others, one important factor is that the kiln insulation of tunnel kilns remains on its temperature while the insulation of intermittent kilns has to be heated up for each firing operation.

As stated above, the material charge continuously travels on the rollers through the kiln, going through several sections at different temperatures, until the product is completely burned and cured. In the first section of the kiln, the raw charge goes through a preheating zone, where the kiln is usually equipped with burners operating only on the lower portion of the charge below the roller level.

In the second section, the charge enters the main firing zone, usually with burners at two levels, above and below the charge. After the firing zone, the charge goes through a transition stage, where most of the hot cooling air will be sucked out of the kiln, and then enters the quick cooling region.

In such cooling region, with no burners, cold air is directly injected into the kiln, above and below the charge. The fourth region the charge goes through is a transition zone called slow cooling, before the fifth and last region, where there occurs the final cooling, where a lot of air is again injected to cool the burned charge down to room temperature.

Some documents of the state of the art teach the implementation of industrial kilns and their respective burners, however nothing is similar to the purposes of the invention hereof.

The document GB 1,559,652 filed on Sep. 20, 1977 describes a kiln for the firing of tiles apparently designed for thermal efficiency, where the tile pieces individually travel through the kiln on rotating rollers, in a way causing the parts (charges) to travel forward. However, such kilns do not decrease gas consumption. There are also roller kilns with double channels, but the occurrence of problems is common, that's why this type of roller kilns did not succeed on the market.

The document GB 2,245,693 filed on Jun. 27, 1991 describes a roller kiln designed to burn ceramic products, where the kiln channel is subdivided by one or more intermediary roofs made of silicone carbide slabs, with burners directed into a space separated by intermediary roofs for the indirect application of heat.

However, such document is intended for an indirect firing process of delicate materials in roller kilns It's not intended to reduce gas consumption.

The British document GB 2,224,105, filed on Oct. 11, 1989, also refers to an industrial kiln. Such kiln has many burners where the secondary air can be used to feed the flame region of the burner, in controlled amounts, according to the content of the kiln gaseous component. Such document refers to the injection of secondary air into conventional burners. It's also widely used nowadays, however in intermittent kilns for sensitive products. The secondary air decreases the flame temperature and increases the gas volume inside the kiln, making it homogeneous. Differently from this invention purpose, the consumption raises a lot.

Another existing solution is described in the patent U.S. Pat. No. 4,884,969, of Nov. 16, 1985. Such document describes a tunnel kiln for ceramic products comprehending a heating section, a burning section and a cooling section where, through gas conduction devices, gases are removed from the cooling section and taken to the burning section, which region comprehends at least one additional burner in a transition region between the burning section and the cooling section. This document has a concept similar to that of the invention hereof, by using the clean air from the cooling section, but conducting it as combustion air via air conducting devices to the burners.

The document PI0822010-7, filed on Jan. 18, 2008, describes a combustion system with a flame “rotation”. The ceramic material combustion system comprehends a kiln divided into different regions at different temperatures, the burner system of the firing zone also comprehends a plurality of burners divided into groups, each burner comprehends a controlling device, and the group of burners are set in a side rotation arrangement and are independently and alternatively activated at present time intervals and on a loop basis to prevent local overheating. However, such combustion system does not comprehend burners on the ceiling and hearth.

Traditionally, kilns for firing bricks and roof tiles comprehend burners on the ceiling. Such burners have vertical flames. As a matter of fact, the ceiling burners fire their flames in a gap between two charges, and the charge is stationary at the firing time. In this regard, the charge does not continuously but intermittently travel inside the kiln.

Accordingly, in conventional kilns for red ceramics, the charge does not go through a homogeneous firing process, in other words, a more intense burning may take place in the regions close to the burners.

In the industrial kilns described in the state of the art, the combustion air comes exclusively from the outside.

The first distinct difference lies in the fact the invention hereof has burners on the ceiling and hearth, burning, preferably, but not limitedly, in the direction opposite to the charge feed, and the charge is in a horizontal position. The burners on the ceiling and on the hearth lead to an improved temperature uniformity in the cross section of the kiln.

The second distinct difference is in the fact that in the invention hereof most of the combustion air comes from inside of the kiln, and is used thanks to the Venturi effect generated by the burners.

Therefore a piping system with a control equipment for the combustion air, which is standard at kilns in the state of the art is not necessary. This reduces investment and maintenance cost.

The burners are Venturi-type burners sucking according to their design exactly that amount of air which is necessary for the most effective combustion.

As bigger and bigger kilns have been manufactured, even 4 meters wide, this invention provides greater temperature homogeneity, thereby decreasing the thermal gradient between the kilns's central and side regions. Additionally, this invention provides a significant increase in thermal efficiency, as it uses hot air as combustion air coming from inside of the kiln sucking that amount of hot combustion air, which is necessary for a most effective combustion, thereby significantly reducing gas consumption.

### BRIEF SUMMARY

Taking into consideration the problems described and in order to eliminate them, a system is proposed in order to decrease gas consumption in the manufacturing of ceramics in particular tiles, as well as to accomplish a high temperature uniformity in the cross section of the kiln as well as to reduce expenses for investment and maintenance because of the abandonment of the piping system for combustion air.

This invention is also intended to provide improved cooling yield.

### BRIEF DESCRIPTION OF THE VARIOUS EMBODIMENTS OF FIGURES

FIG. 1 shows the cross section of the burning zone of a conventional kiln, which uses conventional burners;

FIG. 2 shows a cross section of the burning zone of a kiln with an improved combustion system, using only Venturi-type burners at the ceiling and at the bottom;

FIG. 3 shows the side section of the burning zone of a kiln with an improved combustion system, using only Venturi-type burners at the ceiling and at the bottom;

FIG. 4 shows the cross section of the burning zone of a kiln with an improved combustion system using Venturi-type burners at the ceiling and at the bottom and conventional burners at the ceiling and at the bottom and in the side walls;

FIG. 5 shows the side section of the burning zone of a kiln with an improved combustion system, using Venturi-type burners at the ceiling and at the bottom and conventional burners at the ceiling and at the bottom and in the side walls;

FIG. 6 shows the cross section of the burning zone of a kiln with an improved combustion system using only conventional burners;

FIG. 7 shows the side section of the burning zone of a kiln with an improved combustion system, using only conventional burners;

FIG. 8 shows the cross section of the firing zone of a kiln with an improved combustion system, using only Venturi-type burners in the ceiling and at the bottom and in the side walls.

### DETAILED DESCRIPTION OF VARIOUS EMBODIMENTS

The system described herein can be better understood with the following detailed description of the figures.

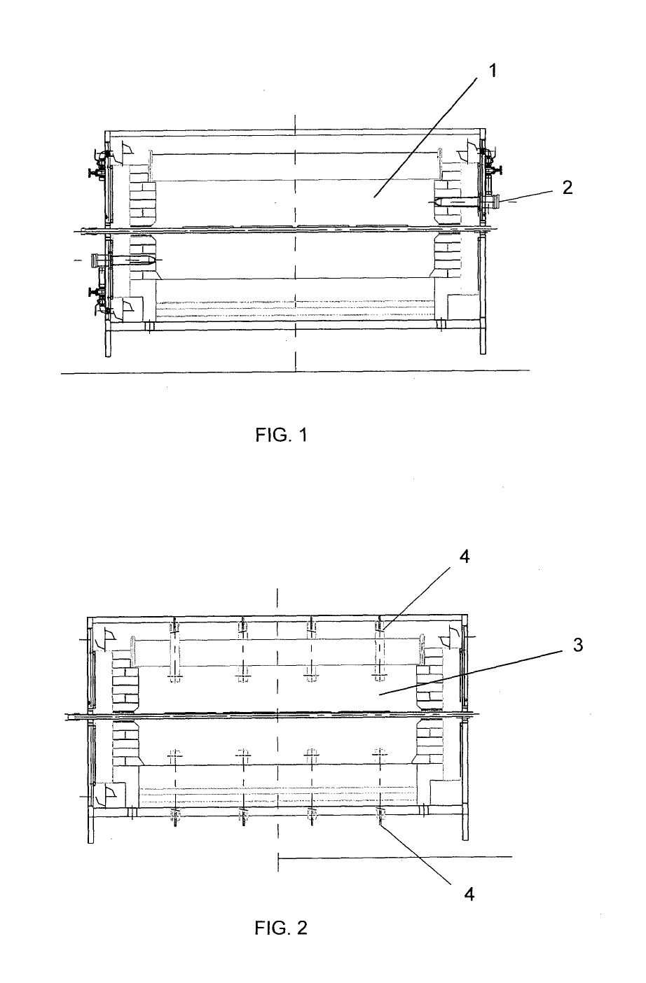

FIG. 1 shows a schematic drawing of the burning zone 1 of a conventional roller hearth kiln, with conventional burners 2 positioned in the side walls of the kiln.

Existing tunnel kilns have burners 2 divided into burning groups. A typical tunnel kiln can have 3-40 burning groups. Each module of the kiln is about 2-3 m long with burners in a 0.75-1.5 m distance to each other, while the burners on the opposite side are installed in this distance gap.

In a preferred mode of this invention, the burning zone comprehends a plurality of burners divided into groups, each burner comprehends a controlling device such as a solenoid valve. The groups of burners on each side have a rotating firing arrangement, it comprises the activation and closing of the burners one after the other, starting and ending with the first one in a loop, independently and alternatively activated at present time intervals to prevent local overheating.

Additionally, instead of using conventional burners in the firing zone (temperatures above 800° C.), burners using only gas or with a small amount of air can be implemented. Due to the temperature above 800° C. the fuel leaving the burners are self-igniting.

FIG. 2 shows the firing zone 3 of a roller kiln with an improved combustion system, using exclusively Venturi type burners 4 on the kiln ceiling and/or hearth.

At least one, but preferably a plurality of burners 4, on the ceiling and/or hearth, is intended to prevent big temperature difference between the center and sides inside the kiln.

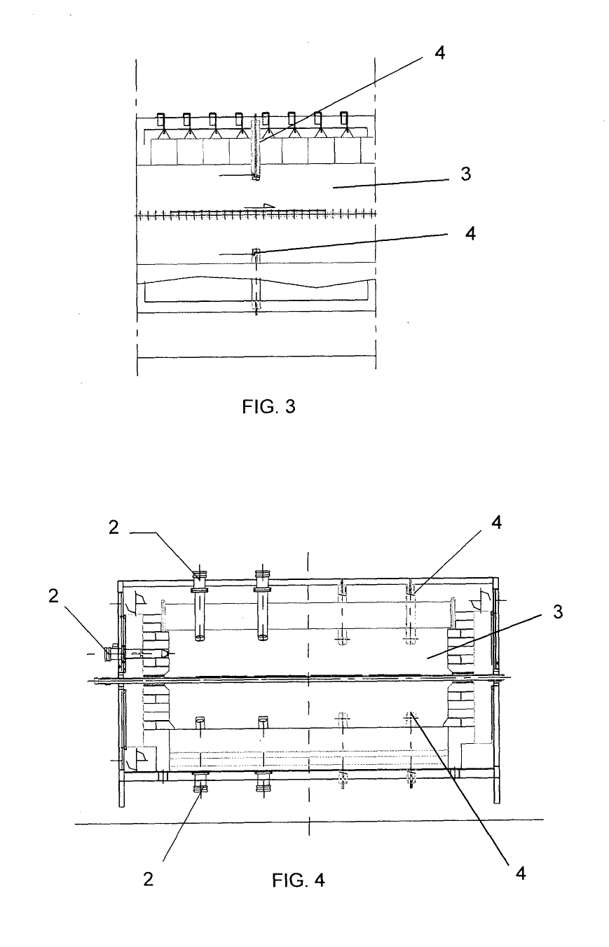

The side view of the firing zone 3 of FIG. 2 is shown in FIG. 3, where the ceiling and hearth burners 4 fire in horizontal direction, preferably in direction opposite to the charge feed.

In FIG. 4 one can see the firing zone 3 of a roller kiln with an improved combustion system, using Venturi-type burners 4 on the ceiling and/or hearth, and also conventional burners 2 on the sides and/or ceiling and/or hearth. Such mode further prevents great temperature difference between the kiln center and sides.

The burners 2, 4 on the ceiling and/or hearth, aligned with the burners 2 on the sides, provide homogeneous firing for the charge, thereby preventing the charge from overheating in the regions close to the burners, while the charge is continuously traveling through the furnace.

The minimum amount of burners 2, 4 on the ceiling and/or the hearth is one; however, preferably, a plurality of such burners 2, 4 is used.

In a preferred mode, the burners 2, 4 of the kiln operate alternatively on a rotation basis. Actually, groups of burners in the sides, ceiling and hearth have a rotating firing arrangement, it comprises the activation and closing of the burners one after the other, independently and alternatively activated at present time intervals to prevent local overheating.

Additionally this combustion system provides a better cooling yield, as it allows larger input of hot air into the burning zone coming from the cooling zone. As a result, most of the combustion air is part of the flow inside the kiln, and can be used thanks to the Venturi effect generated by the burners. It increases the kiln thermal efficiency and reduces gas consumption at the same time.

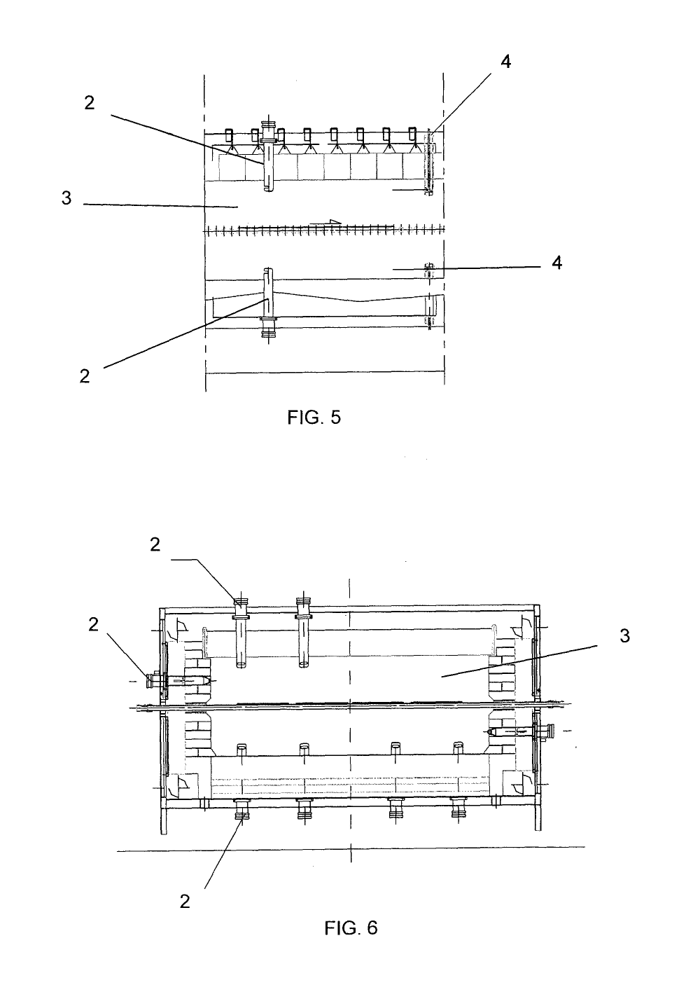

FIG. 5 shows the side view of the firing zone 3 of a kiln with an improved combustion system, as shown in FIG. 4.

One can see the ceiling and hearth burners 2, 4 operate in the horizontal direction, preferably, in a direction opposite to the charge feed.

However, in all the modes of the invention hereof, the flame direction, both of the conventional burners 2 and the Venturi-type burners 4, may be rotated 360 degrees.

Therefore such burners 2, 4 can operate not only in the direction opposite to the charge feed but also in any horizontal direction. Therefore, the temperature homogeneity is further improved along the kiln section.

The burners 2, 4 can also operate alternatively on a rotation basis, and the firing time is controlled by a programmable logic controller (PLC) with dedicated Software.

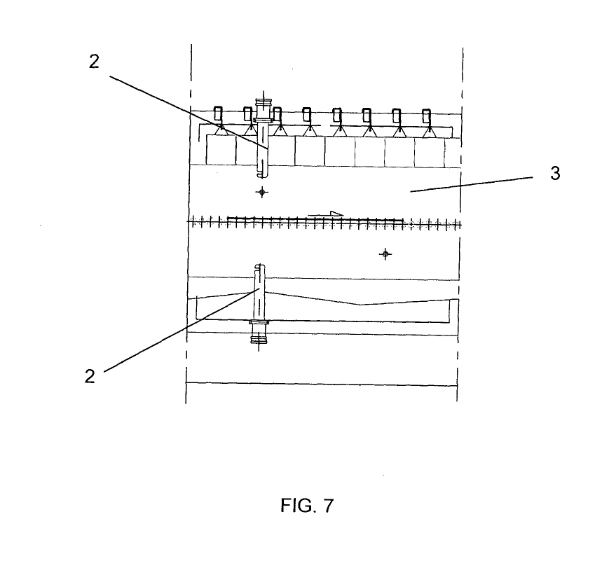

Another mode of the invention hereof is shown in the FIGS. 6 and 7, which show, respectively, the cross section and the side view of the firing zone 3 of a kiln with an improved combustion system, using only conventional burners 2 on the kiln sides and/or ceiling and/or hearth.

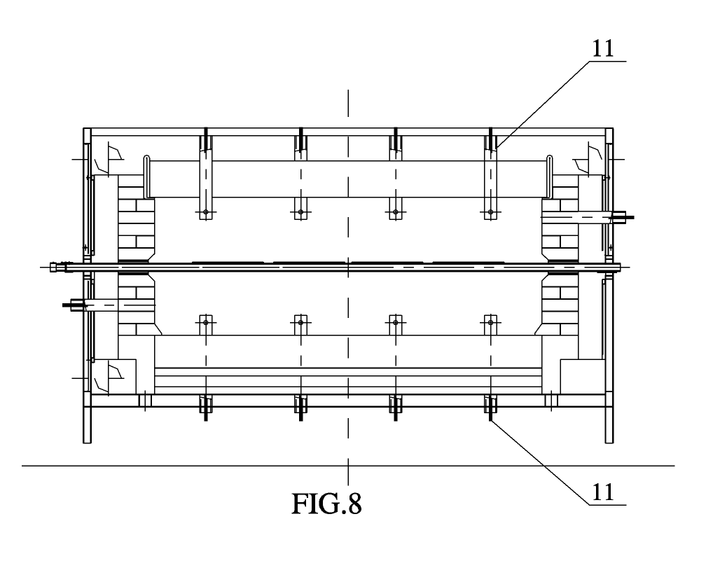

FIG. 8 shows the firing zone 3 of a roller kiln with an improved combustion system, using only Venturi-type burners 4 on the ceiling and/or hearth, and also in the side walls. With this solution it is possible to suck the biggest amount of hot air for combustion, which results in low energy consumption. In connection with the described arrangement of the rotating firing system a good temperature uniformity over the cross section of the kiln channel can be achieved.

Additionally while the Venturi-type burners 4 on the ceiling and/or hearth fire in horizontal direction, preferably in direction opposite to the charge feed, the Venturi-type burners 4 installed in the side walls of the kiln fire in horizontal direction rectangular to the transport direction of the charge or in opposite transport direction of the charge.

Additionally, the conventional burners 2 above and below the charge can also operate as injectors of pure air, in case the adjusted temperature curve of the kiln requires so. In such case, the conventional burners 2 have a ceramic deflector or a tube with proper holes to divert gases in a horizontal direction.

Additionally, to avoid gas cracking, it's possible to cool down the burner tip through a cooling system, preferably with the circulation of a small amount of air. The cooling system may also be a water coating.

Analogously, in order to improve the thermal yield, it is also possible to improve the kiln cooling regions in order to get more air and to transfer more heat from the charge to the air, which will be used as combustion air in the firing zone r. That happens by placing recirculators at the ceiling of the kiln outlet, which will force the cooling air to the charge thereby providing lower temperature to the charge Such feature is equivalent to increasing the furnace size, as though we had “stretched” the furnace outlet.

Another way to increase the amount of hot air, to be used as combustion air, is to use preheated air in the quick cooling fan instead of air with ambient temperature Such air can be removed from the hot air at the kiln outlet.

In another mode, upon the use of roller kilns with internal muffles, the Venturi type burner can be used as a radiating type burner. In this type of burner, gases have at their outlet high tangential speed, thereby causing high radiation intensity of the muffles.

As examples of the preferred modes have been described, one must understand the scope of the invention hereof comprehends other potential variations, limited only by the content of the claims enclosed, including potential equivalents.

1-14. (canceled)

15. Combustion system for the manufacturing of tiles, said system comprising:
a roller kiln, with insulation walls, and divided into different regions at different temperatures; and
a firing zone (3) comprising a plurality of burners (2, 4),
wherein:
at least one of the plurality of burners (2, 4) is installed at the kiln ceiling;
at least one of the plurality of burners (2, 4) is installed at the kiln hearth; and
the flame direction of the plurality of burners (2, 4) can be 360° rotated, thereby enabling the plurality of burners (2, 4) to operate in a horizontal way in any direction concerning the charge feed.

16. Combustion system, according to the claim 15, wherein the plurality of burners comprise of Venturi-type burners (4).

17. Combustion system, according to the claim 15, wherein at least one Venturi type burner (4) is installed at the kiln ceiling and hearth and at least one Venturi type burner (4) is installed in the kiln side walls.

18. Combustion system, according to the claim 15, wherein the plurality of burners comprise a combination of Venturi-type burners (4) and conventional burners (2).

19. Combustion system, according to the claim 18, wherein:
at least one Venturi type burner (4) is installed at the kiln ceiling and hearth; and
at least one conventional burner (2) is installed in the kiln side walls.

20. Combustion system, according to the claim 15, wherein the plurality of burners comprise conventional burners (2).

21. Combustion system, according to the claim 20, wherein at least one conventional burner (2) is installed on the kiln side, ceiling and hearth.

22. Combustion system, according to claim 15, wherein each burner (2, 4) comprises a controlling device.

23. Combustion system, according to claim 15, wherein the burners (2, 4) are divided into groups.

24. Combustion system, according to the claim 23, wherein each group of burners (2, 4) is activated by a programmable logic controller (PLC) with dedicated software.

25. Combustion system, according to claim 15, wherein the burners (2, 4) inject at least one of pure gas, a small amount of air, or only air.

26. Combustion system, according to claim 15, wherein the tip of each injector of the plurality of burners (2, 4) is cooled down by a cooling device.

27. Combustion system, according to the claim 26, wherein the cooling device is at least one of a water coating or a circulation of an amount of air.

28. Combustion system, according to claim 15, wherein the controlling device is a solenoid valve.

29. Combustion system, according to claim 15, wherein the groups of burners are placed in a side rotation arrangement and are independently and alternatively activated at present time intervals and on a loop basis to prevent local overheating.
